(19) United States
(12) Patent Application Publication
(10) Pub. No.: US 2005/0236015 A1
(43) Pub. Date: Oct. 27, 2005

(54) Drill cutting deoiling

(75) Inventors: Ravi K. Goel, Houston, TX (US); Gee Fung, Houston, TX (US); Anant Desai, Houston, TX (US); Puneet Sharma, Houston, TX (US); Simon Seaton, The Woodlands, TX (US); Jeff Kirsner, Humble, TX (US); Lewis R. Norman, Duncan, OK (US)

Correspondence Address: JOHN W. WUSTENBERG, P.O. BOX 1431, DUNCAN, OK, 73536, US

(73) Assignee: Halliburton Energy Services, Inc., Houston, TX (US)

(21) Appl. No.: 10/831,932

(22) Filed: Apr. 26, 2004

(51) Int. Cl. B08B 3/12

(52) U.S. Cl. 134/10; 134/1

(57) ABSTRACT

The present invention features a method and system for extraction of oil from drill cuttings. The extraction is carrying out by using a solvent. The extraction conditions preferably include a temperature and pressure each elevated above ambient and optionally to at least the critical point of the solvent. The cleaned drill cuttings may include not more than 1 wt. % oil.

### CROSS-REFERENCE TO RELATED APPLICATIONS

Not Applicable.

### STATEMENT REGARDING FEDERALLY SPONSORED RESEARCH OR DEVELOPMENT

Not Applicable.

### FIELD OF THE INVENTION

The present invention relates generally to methods and apparatus for removing oil based drilling mud or like contaminants from drill cutting. More particularly, it concerns a system and method that uses a fluid as a solvent to extract the contaminants from the cuttings, and recycles the fluid through the system. Exemplary solvent fluids are light natural hydrocarbon solvents, such as natural gas liquids, propane and butane and other suitable well-born liquids and gases.

### BACKGROUND OF THE INVENTION

It has been possible to efficiently remove oil and gas from the earth, both on land and offshore, for many years. The fluids that are removed may be processed on site as part of the producing operation. For example, natural gas is typically processed to separate natural gas liquids from pipeline quality methane. In particular, in addition to methane, natural gas includes some heavier hydrocarbons and other impurities, e.g., carbon dioxide, nitrogen, helium, water and non-hydrocarbon acid gases. After compression and separation of these impurities, natural gas is further processed to separate and recover natural gas liquid (NGL). Natural gas liquid includes ethane, propane, butane, isobutane, and other C₂₊ hydrocarbons. In some applications, it is desirable to minimize the ethane content of the NGL. In those applications, ethane and more volatile components are separated from propane and less volatile components to yield C₃₊ natural gas liquid. Thus, production fluids may generally include a fluid as directly removed from a well or as processed on site as part of the producing operation.

Technology for exploring for and producing hydrocarbon fluids, such as oil and gas, includes a variety of methods of drilling into a formation to find or remove hydrocarbon fluids. Typically, to remove the fluids from the earth, a wellhole is drilled into the earth on land or under the sea bottom. A drill bit is attached to a drill string, including joined sections of drill pipe. As the drill bit rotates, the hole deepens and the string is lengthened by attaching additional sections of drill pipe.

During drilling operations, drilling fluid is pumped down through the drill pipe and into the hole through the drill bit. Drilling fluids are used to lubricate the drill-bit and keep it cool. The drilling fluid also cleans the bit, and balances pressure by providing weight downhole. The drilling liquid, or “mud” as it is also known, also brings up sludge and cuttings from the drilling process to the surface. Drill cuttings include crushed rock and clay, which accumulate in drilling fluid. Drill cuttings may also include naturally occurring radioactive material. Drilling fluid is typically recycled by separating out drill cuttings on he platform and returning the clean fluid down the hole. Drilling fluids may be either water-based, oil-based, or synthetic oil-based. The drilling fluid may include additional additives chosen from among clay, colloidal polymers, a weighting material such as barite, and various chemicals. Frequently, drilling fluid has included various oils such as diesel fuel and barium sulphate.

It is necessary to dispose of the drill cuttings that accumulate during drilling. In one method of disposing of drill cuttings, the cuttings are reinjected deep into a wellhole for permanent disposal in the earth, on land or at sea. The reinjection process includes the first step of rendering the drill cuttings and drilling fluid into a fine slurry. This method has the disadvantage that the drilling fluid, which may have further utility in the drilling process, is disposed of along with the drill cuttings.

An alternative method of disposing of drill cuttings is to separate the drilling fluid from the drill cuttings, so that they can be further processed separately. This is particularly desirable when the drilling fluid includes oils, such as diesel, mineral oil or synthetic oil. Oily cuttings are environmentally difficult to dispose of. A variety of systems and techniques have been developed to clean oil or oil-based drilling mud from drill cuttings in order to provide for an environmentally safe disposal of the cuttings. Recently, there has been a great deal of activity directed toward development of a practical system that is capable of cleaning contaminated drill cuttings at a remote location so as to allow for disposal of the cleaned cuttings directly into the ocean. Without such a system for cleaning contaminated cuttings, the use of oil muds is a very expensive proposition, since environmental regulations require that oil-contaminated cuttings be hauled from the remote drilling site to a treatment and disposal facility.

One approach to cleaning oil-contaminated or coated cuttings is to burn or evaporate the oil off the cuttings using, for example, very high temperature heat lamps or steam. Examples of this approach are disclosed in U.S. Pat. Nos. 4,209,381, issued on Jun. 24, 1980; 4,595,422, issued on Jun. 17, 1986; and 4,683,963, issued on Aug. 4, 1987. Such systems for burning off the oil from the cuttings suffer from drawbacks, such as only a partial cleaning of the cuttings caused by an unequal heating of the contaminated cuttings.

Another and more practical approach to the offshore cleaning of oil contaminated cuttings is to wash the cuttings with a detergent solution, separate the cuttings from the mixture of wash solution and oil, and then discharge the cleaned cuttings into the environment. U.S. Pat. Nos. 3,688,781 issued on Sep. 5, 1972; 3,693,733, issued on Sep. 26, 1972; and 4,546,783, issued on Oct. 15, 1985 disclose examples of such washing systems or associated methods. These conventional washing systems are less than desirable because they do not provide the necessary cleaning, the washing solution itself may pose a threat to the environment, and/or they require periodic shutting down of the system to allow for the settling of oily particles or for the removal of a highly contaminated washing solution which must be hauled to an approved onshore disposal site.

Yet another approach to cleaning oil contaminated drill cuttings involves the use of specialized solvents that are usually miscible with oil but essentially immiscible with water and which may be in liquid form during one stage of the cleaning process and in vapor form during another stage of the process. For example, U.S. Pat. No. 4,836,302 discloses a complex apparatus for removing and recovering oil and other oil-based drilling mud additives from drill cuttings using an easily vaporized solvent, such as trichlorotrifluoethane. Such a complex separation system is undesirable not only from the standpoint of unit cost, but also high operating costs and problems associated with the use of volatile and/or environmentally dangerous solvents. Other examples of specialized cleaning solvents are disclosed in U.S. Pat. Nos. 4,040,866, and 4,645,608.

In light of the above, there is a need for an improved system for thoroughly and safely cleaning oil contaminated drill cuttings prior to disposal.

### SUMMARY OF THE INVENTION

The present invention features a method and system for cleaning oil from drill cuttings including extraction of the oil. The extraction is carrying out using a solvent such as a natural gas liquid. The cleaned drill cuttings preferably include not more than 1 wt. % oil. Exemplary solvents are C₂₋₄ natural gas liquids, ethane, butane, propane, and combinations thereof.

The present process may include the steps of grinding the drilling fluid to reduce the particle size of the drill cuttings, contacting the drilling fluid with a solvent at optimum extraction conditions, separating the used solvent mixture from the drill cuttings; repeating the extraction and separation, adjusting the conditions of the drill cuttings to ambient, and recycling the solvent. The solvent may be recycled together with extracted drilling fluid into the producing operation. Alternatively, the solvent may be transferred into another oil and gas process system. Still alternatively, the solvent may be separated from the drilling fluid and recycled back to be used in the extraction.

The system may include a mulcher for grinding said drill cuttings, a sludge pump connected to the mulcher for raising the pressure of the drilling fluid, an extraction unit connected to the sludge pump, and a solvent recycling unit connected to the separator and the extraction unit. Preferably, the extraction unit includes an extraction cell and a separator. Used solvent is fed to the solvent recovery unit from the separator and returned to the extraction cell. The recycling unit preferably includes a depressurizing valve for vaporizing said solvent, a vapor-liquid separator, and a solvent compressor.

A particular advantage of the present invention is the ability to recycle the solvent, either into the extraction system or possibly into hydrocarbon production operations.

Thus, the present invention comprises a combination of features and advantages which enable it to overcome various problems of prior devices. The various characteristics described above, as well as other features, will be readily apparent to those skilled in the art upon reading the following detailed description of the preferred embodiments of the invention, and by referring to the accompanying drawings.

### BRIEF DESCRIPTION OF THE DRAWINGS

For a more detailed description of the preferred embodiment of the present invention, reference will now be made to the accompanying drawings, wherein:

FIG. 1 is a schematic of a deoiling unit, illustrated for a natural gas liquid solvent; and

FIG. 2 is a schematic of a solvent recovery unit, illustrated for a natural gas liquid solvent.

### DETAILED DESCRIPTION OF THE PREFERRED EMBODIMENT

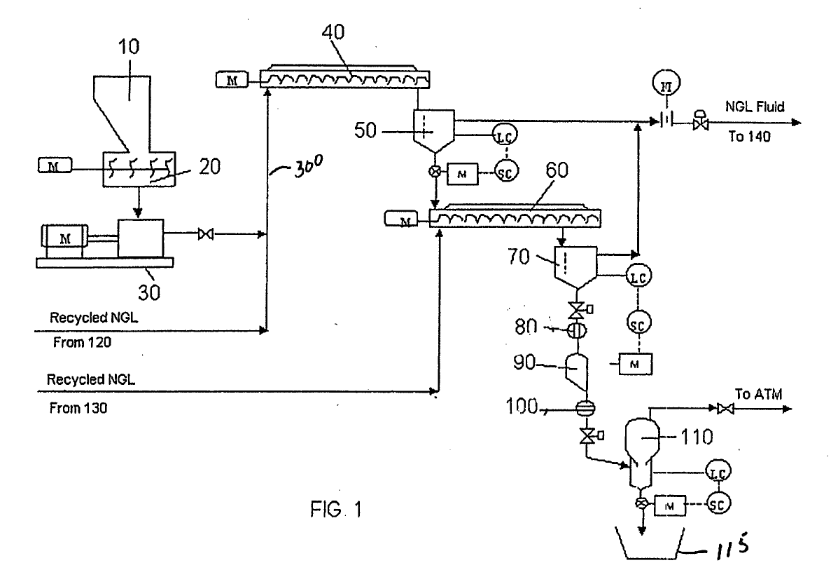

With reference to FIG. 1, an exemplary extraction system for deoiling drill cuttings includes feed hopper 10, sludge mulcher 20, sludge pump 30, primary extraction cell 40, primary separator 50, secondary extraction cell 60, secondary separator 70, solid hopper 90, degasser 110, and solvent recovery unit 120.

Still referring to FIG. 1, a used drilling fluid containing drill cuttings is fed into the feed hopper 10. The extraction process design is able to handle wide variations in feed composition and a wide variety of oils. The used drilling fluid typically contains 5-50 wt. % water, 5-50 wt. % oil, with the remaining wt. % being solids. Typically, the oil may be mineral oil, or diesel oil. Preferably, the extraction unit is capable of handling 200 bbls/day of drill cuttings. The drill cuttings typically contain about 50% by volume of oil-based drilling fluid adsorbed within the intergranular spaces or voids (pores) of the drill cuttings. The used drilling fluid may have already been subjected to a process to reduce the amount of oil that is mixed with the drill cuttings. One such process comprises placing the used drilling fluid in a settling tank to allow some part of the oil based drilling fluid to separate by gravity from the drill cuttings. Alternately, the used drilling fluid may be taken directly out of the drilling fluid circulation system of the offshore drilling rig or platform.

From feed hopper 10, the used drilling fluid is sent to sludge mulcher 20. Sludge mulcher 20 grinds the cuttings within the used drilling fluid to a desired particle size distribution, for example such as may be required by sludge pump 30. Sludge mulcher 20 preferably acts on the drill cuttings while they are still admixed within the drilling fluid.

From sludge mulcher 20, the used drilling fluid is sent to sludge pump 30. Sludge pump 30 raises the pressure of the drilling fluid to a level above ambient pressure. The elevated pressure of the drilling fluid is preferably about equal to the pressure of the solvent at the fluid extraction conditions described below, such as the pressure of the solvent at its optimum solubility point for drilling oil.

From sludge pump 30 the used pressurized drilling fluid is sent to primary extraction cell 40. Primary extraction cell 40 may be any suitable extraction apparatus as is known in the art including a continuing stir tank, a reactor, a aguar, and other devices that enhance mass transfer. In one embodiment, primary extraction cell 40 includes a screw conveyor, which is used to mix the solvent and the used drilling fluid and move the mixture forward at a fixed rate. The screw system allows slow agitation and good mixing of solvent and drill cuttings. Solvent enters primary extraction cell 40 via line 300 originating in solvent recovery unit 120. Preferably, the extraction cell is maintained at fluid extraction conditions at which the solvent has an optimal solubility point with respect to drilling oil.

The fundamental principles of fluid extraction, including optimal fluid extraction and supercritical fluid extraction, are known within the art. The fundamental principles of fluid extraction can be found, for example, in section 1.1, 1.2, 1.9, and 1.10 of “Handbook of Separation Techniques For Chemical Engineers” 2^{nd} Ed , Philip A. Schweitzer Editor-In-Chief. For example, according to the McGraw-Hill Dictionary of Scientific and Technical Terms, 2^{nd} Edition, page 379, the critical point is “the temperature and pressure at which two phases of a substance in equilibrium with each other become identical, forming one phase.” Further, fluid extraction processes known in the art have been proposed for a variety of uses as solvents and extractants, such as for coffee decaffeination, extraction of spices, and petroleum separations. Typically, the solvent used in an application depends on the substance to be treated. For example, as disclosed in “Supercritical Fluid Extraction”, by McHugh and Kukronis, pp. 9-10, CO₂ and other fluids with critical temperatures near ambient are preferred solvents for processing heat sensitive materials, such as some pharmaceuticals and C₅ and C₆₊ hydrocarbons are preferred to process nonvolatile substances such as coal and high molecular weight petroleum fractions.

The properties of a selected fluid, either in an optimal or in a supercritical state, make that fluid useful for both separating components of a mixture and for acting as a solvent. A selected fluid preferably has a gas-like diffusivity and viscosity, a liquid-like density and a pressure dependent solvent power. Further, the very low surface tension of selected fluids allows facile penetration into microporous materials. This is an advantage in extracting oil from drill cuttings, due to the adsorption of oil on the surface of pores of particles of drill cuttings.

Solvents preferred for use in the present invention include, ethane, propane, butane, other C₂₋₄ natural gas liquids and combinations thereof, with the preferred solvents being butane and propane. These solvents have been tested in the laboratory and it has been established that oil is adsorbed. A particular advantage of the present invention is the ability to recycle the solvent into the extraction system.

In a preferred embodiment the fluid extraction conditions include optimal extraction conditions of about an optimum hydrocarbon solubility point for the solvent, more preferably an optimum drilling fluid solubility point. It is understood that the optimum extraction conditions may vary with the composition of the drilling fluid and with the solvent used. The optimal extraction pressure and temperature may be determined for a given system using techniques known in the art. For example, the method of determining the equilibrium data (binary constant for the activity coefficients equation) is well known and covered in section 1.1 and 1.2 of “Handbook of Separation Techniques For Chemical Engineers” 2^{nd} Ed, Philip A. Schweitzer Editor-In-Chief.)

From the primary extraction cell 40, the solvent mixture is transferred to the primary separator 50. Primary separator 50 separates the used solvent fluid from the cuttings. The used solvent fluid includes the extracted oil. The primary separator 50 may include any separations as are known in the art, such as separators using centrifugal or gravitational forces, such as filters or screens, to separate the solids from the liquids. From primary separator 50 the solvent is fed to solvent recovery unit 120.

The first stage of extraction, described above, removes most of the oil from the drill cuttings. A second stage is preferably included following the first stage. In the second stage, substantially all of the remaining solvent and oil is recovered for recycling. Further, there are minimal air emissions in the second stage The second stage apparatus includes secondary extraction cell 60 and secondary separator 70.

From primary separator 50, the drill cuttings mixed with the remaining drilling fluid are fed to the secondary extractor 60. The cuttings leave the bottom of primary separator 50 and enter the secondary extraction cell 60. In secondary extraction cell 60 oil is extracted from the used drilling fluid again. Preferably the solvent is recycled solvent. Preferably the secondary extraction cell is a screw conveyor, which is used to mix the solvent and the cuttings and move the mixture forward at a fixed rate. The screw system allows slow agitation and good mixing of solvent and drill cuttings. Alternatively, the secondary extraction cell may be any suitable extraction cell as is known in the art, as described above. Preferably the recycled solvent is fed to secondary extraction cell 60 in an optimal oil solubility state. This state may include a pressure above or below the solvent critical pressure.

From secondary extraction cell 60, the mixture is transferred to the secondary separator 70. The secondary separator 70 separates the solvent fluid from the cuttings. The solvent fluid includes the extracted oil. The secondary separator 70 may be chosen from among any suitable separators as are known in the art, such as separators using centrifugal or gravitational forces, including filters and screens. From secondary separator 70, the solvent is fed to solvent recovery unit 120. Preferably the secondary separator 70 is maintained in an optimum oil solubility state.

From secondary separator 70, the cuttings are fed to solid hopper 90. Alternately, if only one stage of extraction is used, the cuttings are fed to said hopper 90 from primary separator 50. The pressure of the treated cuttings is reduced by use of motorized valves together with solid hopper 90. From the solid hopper 90, the cuttings are fed to the degasser 110. In the degasser, the pressure of the cuttings is dropped to approximately atmospheric pressure. The remaining solvent gas is relieved to the atmosphere and the treated cuttings are dumped to a bin 115.

Used solvent fluid exiting from primary separator 50 and from secondary separator 70 is treated in solvent recovery unit 120. The used solvent contains oil, as well as water admixed therein. Solvent recovery unit 120 includes components of the deoiling apparatus used to separate and recover the solvent for recycling. These components of solvent recovery unit 120 may be mechanically distinct and separate from the extraction equipment.

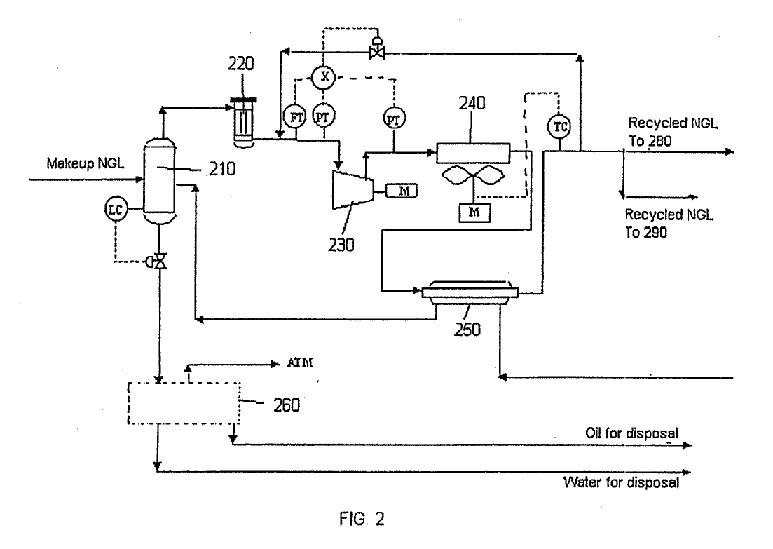

Now referring to FIG. 2, an exemplary solvent recovery unit includes heater/cooler 250, solvent-fluid separator 210, water-oil separator 260, solvent compressor inlet filter 220, solvent compressor 230, and solvent cooler 240. Used solvent passes first through a control valve where the pressure is reduced and the temperature is reduced due to the Joule-Thomson effect. The used solvent mixture is heated in heater-cooler 250. From heater-cooler 250 the used solvent mixture is sent to solvent-fluid separator 210. Make-up solvent is added at solvent-fluid separator 210 may be required. In solvent-fluid separator 210, vapor phase solvent is separated from the liquid phase, which includes oil and water extracted from the drilling fluid. The liquid phase is sent to oil-water separator 260, where the oil and water are separated using any suitable conventional technique, such as CPI, IGF, DAF, hydrocyclone and the like.

From solvent-fluid separator 210, recovered solvent is sent to solvent compressor inlet filter 220. Solvent compressor inlet filter 220 removes any residual solids. From solvent compressor inlet filter 220 the solvent is fed to solvent compressor or pump 230. Solvent compressor or pump 230 pressurizes the solvent. The solvent discharged from compressor or pump 230 is preferably partially cooled in solvent cooler 240 and then further cooled in heater/cooler 250. The cooled solvent is preferably recycled back to the primary and secondary extraction cells 40, 60 to remove oil from the drill cuttings.

Further, the preferred embodiment may be operated either in a batch or continuous manner. Methods of batch or continuous mixing, separation and handling are all known in the art and available. The preferred process may include an optimized engineering system selected based on the desired operating conditions.

Preferably, the total petroleum hydrocarbon content is less than 1% after deoiling, in order to comply with environmental regulations. Removal to less than 1000 ppm could be required in some cases. The type of drilling fluid used may vary, along with its water content, as well as the composition of the earth stratum being drilled in.

While preferred embodiments of this invention have been shown and described, modifications thereof can be made by one skilled in the art without departing from the spirit or teaching of this invention. The embodiments described herein are exemplary only and are not limiting. Many variations and modifications of the system and apparatus are possible and are within the scope of the invention. Accordingly, the scope of protection is not limited to the embodiments described herein, but is only limited by the claims that follow, the scope of which shall include all equivalents of the subject matter of the claims.

1. A process of cleaning hydrocarbons from drill cuttings, said hydrocarbons having accumulated on said drill cuttings in the course of a drilling operation, the process comprising:
a) contacting the drill cuttings with a solvent in an extraction cell maintained at fluid extraction conditions sufficient to produce a used solvent mixture comprising drill cuttings and used solvent fluid, the used solvent fluid including at least a portion of said hydrocarbons, said solvent comprising a natural gas liquid;
b) separating the used solvent mixture into cleaned drill cuttings and used solvent fluid.

2. The method according to claim 1, further including the step of
c) recycling used solvent fluid into step a).

3. The process of claim 1, further comprising:
c) regenerating the solvent, comprising separating the used solvent fluid into solvent and drilling liquid.
d) returning the regenerated solvent to the extraction cell.

4. The process of claim 3, wherein regenerating the solvent further comprises:
c1) reducing the solvent pressure, such that the solvent vaporizes;
c2) allowing solvent vapor to separate from liquid; and
c3) compressing said solvent vapor, and, optionally,
c4) returning the solvent temperature and pressure to the fluid extraction conditions.

5. The process of claim 3 wherein the drilling fluid further includes water, further comprising separating the water from the hydrocarbons.

6. The method according to claim 1, further including the step of
c) including at least a portion of the used solvent fluid in a production stream.

7. The method according to claim 1, further including the step of
c) recycling a first portion of the used solvent fluid into step a) and including a second portion of the used solvent fluid in a production stream.

8. The process of claim 1 wherein cleaned drill cuttings comprise not more than 1 wt. % oil.

9. The process of claim 1 wherein the solvent comprises C₃₊ natural gas liquid.

10. The process of claim 1, further comprising:
grinding the drilling fluid such that the particle size of the drill cuttings is reduced before or during step a).

11. The process of claim 1, further comprising:
adjusting the conditions of said cleaned drill cuttings to approximately ambient conditions.

12. (Canceled).

13. A process of cleaning oil from drill cuttings, accumulated in drilling fluid in a hydrocarbon-producing operation, comprising:
contacting a solvent with the drilling fluid in an extraction cell maintained at fluid extraction conditions to produce a used solvent mixture including a portion of said oil, wherein the solvent comprises a natural gas liquid;
separating the used solvent mixture into cleaned drill cuttings and used solvent fluid, such that the drill cuttings comprise no more than 1% wt. oil;
adjusting the conditions of said cleaned drill cuttings to about the same as ambient conditions.
regenerating the solvent;
returning the regenerated solvent to the extraction cell.

14. (Canceled).
